(19) United States
(12) Patent Application Publication
(10) Pub. No.: US 2012/0239478 A1
(43) Pub. Date: Sep. 20, 2012

(54) Systems and Methods for Employee Rewards

(75) Inventors: Sizhao Yang, Santa Monica, CA (US); George Ishii, Gardena, CA (US); Ian Yap, Los Angeles, CA (US); Ling Lau, Los Angeles, CA (US); Ron Yang, Santa Monica, CA (US); Kuangwei Hwang, Los Angeles, CA (US)

(73) Assignee: BETTERWORKS INC., Santa Monica, CA (US)

(21) Appl. No.: 13/400,001

(22) Filed: Feb. 17, 2012

Related U.S. Application Data
(60) Provisional application No. 61/444,676, filed on Feb. 18, 2011.

(51) Int. Cl. G06Q 30/02; G06Q 30/06

(52) U.S. Cl. 705/14.23; 705/26.1

(57) ABSTRACT

Vendor information relating to a plurality of vendors is transmitted to an employer. The vendor information of each vendor includes a respective offering of the vendor, including a description and cost of the offering. A selection of a respective offering of a vendor is received from the employer, including a co-payment amount the employer is willing to contribute. A benefits package is created including the selected offering and the co-payment amount. An invitation to participate in the benefits package is transmitted to an employee of the employer. An acceptance of the invitation to participate in the benefits package is received from the employee. The employer is charged the co-payment amount and the employee is charged an amount equal to the cost of the offering net of the co-payment amount and an order for the offering is created on behalf of the employee.

### RELATED APPLICATIONS

The present application claims priority to U.S. Provisional Patent Application Ser. No. 61/444,676, entitled “SYSTEM AND METHOD FOR MANAGING RELATIONSHIP AMONG EMPLOYEES, EMPLOYERS, AND GOODS/SERVICES VENDORS,” filed Feb. 18, 2011, which is incorporated herein by reference in its entirety.

### COPYRIGHT NOTICE

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD OF THE TECHNOLOGY

At least some embodiments disclosed herein relate, in general, to systems for the employee rewards, and in particular to managed order fulfillment systems for employee rewards

### BACKGROUND

Employers often provide their employees with perks and rewards as part of a comprehensive benefits package and to encourage desirable behavior. The various types of perks and rewards that an employer can offer their employees can include discounts and co-payments for goods and services. Such goods and services can include any type of product that may be of interest to employees including, for example, food and health and wellness products.

### BRIEF DESCRIPTION OF THE DRAWINGS

The embodiments are illustrated by way of example and not limitation in the figures of the accompanying drawings in which like references indicate similar elements.

FIG. 1 illustrates an embodiment of a high-level overview of an employee rewards service provider and a network configuration through which the provider interacts with employers, employees, goods and services providers and financial institutions to implement employee rewards programs.

FIG. 2 shows a block diagram of a data processing system that can be used in various embodiments of the disclosed systems and methods.

FIG. 3 shows a block diagram of a user device that can be used in various embodiments of the disclosed systems and methods.

FIG. 4 illustrates an exemplary user interface that enables an employer to estimate the cost of a perks package.

FIG. 5 illustrates an exemplary user interface that enables an employer to customize a perks package.

FIG. 6 illustrates an exemplary user interface that enables an employer to provide basic business information to the employee rewards service.

FIG. 7 illustrates an exemplary user interface that enables an employer to provide a means to fund co-payments for employees that participate in the perks package.

FIG. 8 illustrates an exemplary user interface for inviting employees to participate in a perks package.

FIG. 9 illustrates an exemplary dashboard that summarizes employee participation in an employer's perks package.

FIG. 10 illustrates an exemplary user interface that enables an employee to customize his or her participation in a perks program.

FIG. 11 illustrates an exemplary user interface that enables an employee to display the details of a perk.

FIG. 12 illustrates an exemplary user interface that enables an employee to provide basic contact information and payment information.

FIG. 13 illustrates an exemplary user interface that confirms an employee's purchase of one or more perks.

FIGS. 14a and 14b illustrates an exemplary vendor dashboard user interface that enables vendors participating in the employee rewards service to monitor events of interest to the vendors and to maintain a profile for the vendor.

FIG. 15a-15b shows an exemplary procedure for providing co-payments for employee perks.

FIG. 16 shows an exemplary procedure an employee may use to purchase goods or services using a co-payment account.

FIG. 17 shows how an offer can be made to a group of employees simultaneously. An example of where this is useful is in the context of an employee luncheon.

FIG. 18 illustrates an exemplary interaction among an employer, vendors, employees, and an employee rewards service.

FIG. 19 illustrates an exemplary interaction among an employer, vendors, employees, and an employee rewards service in relation to food services.

FIG. 20 illustrates an exemplary interaction among an employer, vendors, employees, and an employee rewards service in relationship to a gym or health club membership.

FIG. 21 illustrates an exemplary interaction among an employer, vendors, employees, and an employee rewards service in relationship to fulfilling an order.

FIG. 22 illustrates an exemplary interaction between a vendor and the employee rewards service.

### DETAILED DESCRIPTION

The following description and drawings are illustrative and are not to be construed as limiting. Numerous specific details are described to provide a thorough understanding. However, in certain instances, well-known or conventional details are not described in order to avoid obscuring the description. References to one or an embodiment in the present disclosure are not necessarily references to the same embodiment; and, such references mean at least one.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described, which may be requirements for some embodiments but not other embodiments.

The present disclosure is directed to systems and methods for implementing an employee rewards service. In various embodiments, the employee rewards service manages the relationship between three categories of users: employees, employers, and service/product vendors. In an embodiment, employers can sponsor their employees' spending on the employee rewards service as part of their benefit package for their employees. For the purposes of the present disclosure, the terms “reward” and “perk” are used interchangeably, and refer to, without limitation, any type of perk, reward, award, recognition, benefit, bonus or incentive provided by an employer to its employees for any reason.

In an embodiment, employers select a budget and pre-pays for into a stored value account. When the employer invites the employees, then the employees are enabled to logon to the service and select the perk using the stored value account. In an embodiment, employers do not pre-pay into a stored value account, but rather employers perk related charges such as, for example, co-payments, are charged to an employer financial account, such as a credit card, debit card or checking account on a “pay as you go” basis. In an embodiment, employers and employees are enabled to browse, select, manage, pay, and fulfill the local vendor's product/services via the employee rewards service. In an embodiment, employees can make purchases from vendors through the employee rewards service, and the service delivers the orders to the vendors and ensures the fulfillment of the delivered orders.

In an embodiment, the fulfillment of orders for goods and services includes individual and group ordering flows. For individuals, the employee rewards service submits orders and provides methods for the vendor to verify the order through a variety of mechanisms including email, fax, printed lists, interactive voice response systems, and printed order forms. In an embodiment, for group orders, the employee rewards service, batches order requests and through a queuing process executes the order at a certain times allowing multiple people to order in an asynchronous manner. In an embodiment, the employee rewards service takes care of the order, look at the global policies/permissions, vendor specific policies/contracts, and the category of the local vendor, select the appropriate fulfillment framework and executes methods fulfill the actual order. In an embodiment, the employee rewards service allows the employers to measure and adjust their sponsoring amount and benefit selection to better accommodate the needs of their employees.

In an embodiment, the employee rewards service manages the flow of money between the three parties. In an embodiment, employers prepay the money they allocated to sponsor their employees' perks. In an embodiment, the employee rewards service will collect money from the employer either through credit card or ACK. The employee rewards can also collect money from the employees via credit card only if their purchase is greater than the sponsored amount.

In an embodiment, the employee rewards service pays out to the vendors by ACK. All transactions can be either recurring or one-time depending on the use cases. The subscriptions, the billing, and the payments are all handled by the employee rewards service on behalf of the employer and the vendor. In an embodiment, the employee rewards service calculates all the taxes based on locations, product taxability, and remits the appropriate sales taxes according the calculations.

In various embodiments, the employee rewards service enables an employer to set up prepaid, or pay as it goes, accounts with the employee rewards service and divides its workforce into groups and subgroups. The employer can set limits on the size of co-payments available for individual employees and can give different amounts to different employees and can thus use co-payments as a bonus program to a group and/or as a reward system to be given to a subgroup.

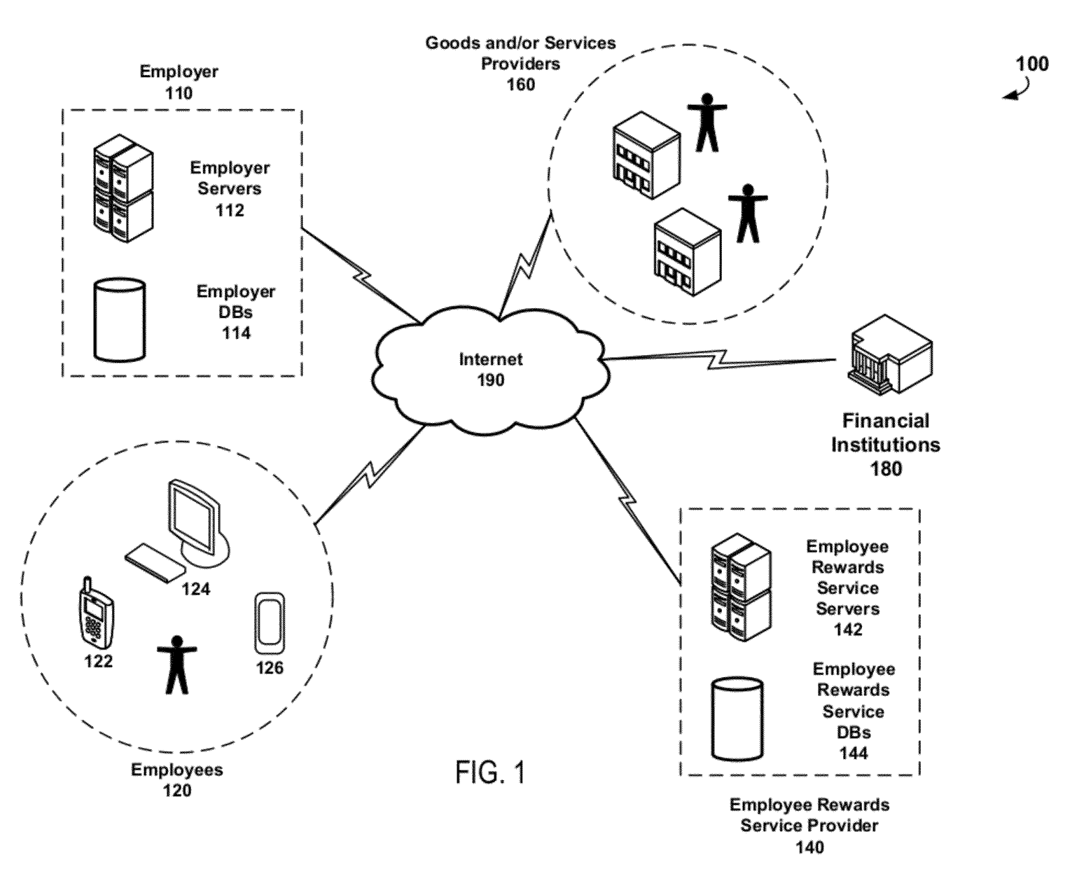

FIG. 1 illustrates an embodiment of a high-level overview 100 of an employee rewards service provider 140 and a network configuration through which the provider interacts with employer 110, employees 120, goods and services providers 160 and financial institutions to implement employee rewards programs.

In the illustrated embodiment, an employer 110 has group of employees 120. Among the various benefits the employer 120 provides to its employees 140 are employee rewards programs including, for example, virtual recognition programs, and programs offering discounts and/or co-payments for goods and services from a variety of goods and services providers 160. In an embodiment, an employee rewards program is implemented using the services of an employee rewards service provider 140.

In an embodiment, employers 110 can access employee rewards services hosted by the employee rewards service servers 142 via the Internet 190. For example, in an embodiment, the employer 110 may access employee rewards services to define employees and employee rewards programs to the employee rewards service provider 140. In an embodiment, the employee rewards services stores such employee and program definitions on one or more employee rewards service databases 144.

In an embodiment, employees 120 can access employee rewards services hosted by the employee rewards service servers 142 via the Internet 190. For example, in an embodiment, the employer 110 may access employee rewards services to enroll in or claim benefits provided via employee rewards service provider 140. In an embodiment, the employee rewards services stores such benefits claims and benefit enrollments on the employee rewards service databases 144.

In an embodiment, certain employee rewards program benefits, such as goods and services, are supplied to employees 140 via goods and service providers 160. In an embodiment, the employee rewards service provider 140 can connect to goods and service providers 160 via the Internet to manage end-to-end delivery of rewards and incentives to employees. In an embodiment, the employee rewards service provider 140 interfaces with financial institutions 180 to debit and credit accounts maintained on behalf of employees 110 and to arrange for payment of vendors for goods and services purchased by employees 110 via the service.

It should be understood that the systems and network configurations illustrated in FIG. 1 are purely exemplary, and numerous other possible implementations will be readily apparent to those skilled in the art. For example, the employer servers 112 and/or the employee rewards service servers 142 could each represent a single server or a cluster of servers maintained by, or under the control of, an employer or an employee rewards service, or could represent facilities maintained and controlled by a third entity on behalf of an employer or an employee rewards service. In other embodiments, the employer servers 112 and/or the employee rewards service servers 142 could each represent virtual servers, for example, within a cloud-based infrastructure.

Additionally or alternatively, the employer databases 114 and/or the employee rewards service databases 144 could each represent a single database or a cluster of databases maintained by, or under the control of, an employer or an employee rewards service, or could represent facilities maintained and controlled by a third entity on behalf of an employer or an employee rewards service. In other embodiments, the employer databases 114 and/or the employee rewards service databases 144 could each represent virtual storage facilities, for example, within a cloud-based infrastructure.

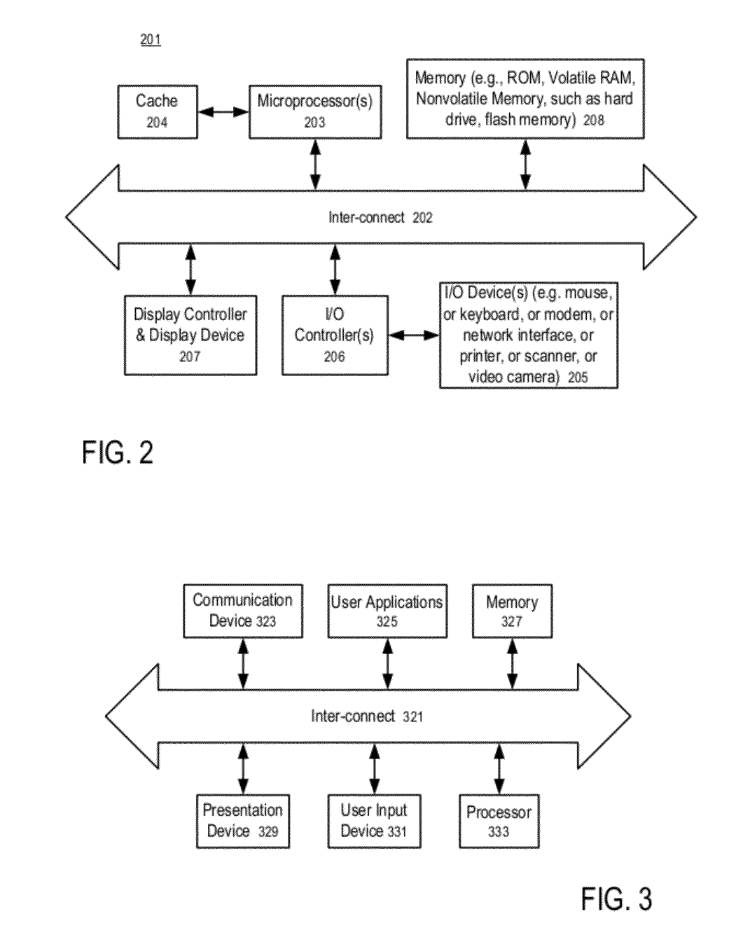

FIG. 2 shows a block diagram of a data processing system that can be used in various embodiments of the disclosed system and method. While FIG. 2 illustrates various components of a computer system, it is not intended to represent any particular architecture or manner of interconnecting the components. Other systems that have fewer or more components may also be used.

In FIG. 2, the system 201 includes an inter-connect 202 (e.g., bus and system core logic), which interconnects a microprocessor(s) 203 and memory 208. The microprocessor 203 is coupled to cache memory 204 in the example of FIG. 2.

The inter-connect 202 interconnects the microprocessor(s) 203 and the memory 208 together and also interconnects them to a display controller and display device 207 and to peripheral devices such as input/output (I/O) devices 205 through an input/output controller(s) 206. Typical I/O devices include mice, keyboards, modems, network interfaces, printers, scanners, video cameras and other devices that are well known in the art.

The inter-connect 202 may include one or more buses connected to one another through various bridges, controllers and/or adapters. In one embodiment the I/O controller 206 includes a USB (Universal Serial Bus) adapter for controlling USB peripherals, and/or an IEEE-1394 bus adapter for controlling IEEE-1394 peripherals.

The memory 208 may include ROM (Read-Only Memory), and volatile RAM (Random Access Memory) and non-volatile memory, such as hard drive, flash memory, etc.

Volatile RAM is typically implemented as dynamic RAM (DRAM) that requires power continually in order to refresh or maintain the data in the memory. Non-volatile memory is typically a magnetic hard drive, a magnetic optical drive, or an optical drive (e.g., a DVD RAM), or other type of memory system which maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In an embodiment, the employee rewards servers 142 of FIG. 1 are implemented using one or more data processing systems as illustrated in FIG. 2. As noted above, in some embodiments, one or more servers of the system illustrated in FIG. 2 are replaced with the service of a peer-to-peer network or a cloud configuration of a plurality of data processing systems, or a network of distributed computing systems. The peer-to-peer network, or cloud based server system, can be collectively viewed as a server data processing system.

Embodiments of the disclosure can be implemented via the microprocessor(s) 203 and/or the memory 208. For example, the functionalities described above can be partially implemented via hardware logic in the microprocessor(s) 203 and partially using the instructions stored in the memory 208. Some embodiments are implemented using the microprocessor(s) 403 without additional instructions stored in the memory 208. Some embodiments are implemented using the instructions stored in the memory 208 for execution by one or more general-purpose microprocessor(s) 203. Thus, the disclosure is not limited to a specific configuration of hardware and/or software.

FIG. 3 shows a block diagram of a user device, such as the devices 142, 144 and 146 of FIG. 1 according to one embodiment. In FIG. 3, the user device includes an inter-connect 321 connecting a communication device 323, such as a network interface device, a presentation device 329, such as a display screen, a user input device 331, such as a keyboard or touch screen, user applications 325 implemented as hardware, software, firmware or a combination of any of such media, such various user applications (e.g. apps), a memory 327, such as RAM or magnetic storage, and a processor 333 that, inter alia, executes the user applications 325.

In one embodiment, the user applications implement one or more user interfaces displayed on the presentation device 329 that provides users the capabilities to, for example, access the Internet, send and receive messages and/or receive and display offers, incentives and rewards transmitted by a employee rewards service provider such as the provider 140 of FIG. 1 or an employer such as the employer 110 of FIG. 1. In one embodiment, user applications 325 on the user device use the communication device 323 to communicate with employee rewards servers such as that shown in 142 of FIG. 1 to retrieve data relating to employee offers, incentives and rewards. In one embodiment, user applications 325 on the user device use the communication device 323 to communicate with employer servers such as that shown in 112 of FIG. 1 to retrieve data relating to employee offers, incentives and rewards.

In one embodiment, users use the user input device 331 to interacts with the device via the user applications 325 supported by the device, for example, by accessing and interacting with websites offers, incentives and rewards described in detail above with respect to FIG. 1. The user input device 331 may include a text input device, a still image camera, a video camera, and/or a sound recorder, etc.

### Employer Registration, Exemplary User Interfaces

In an embodiment, an employer initially registers with the employee rewards system and creates a perks package for his or her employees. For the purpose of the present disclosure, the terms “perks package” and “benefits package” are used interchangeably and refer to a package of one or more of any type of perk, reward, award, recognition, benefit, bonus or incentive provided by an employer to one or more of its employees for any reason. Basic aspects of the process of setting up a perks package include:
Specifying the sponsorship allocation.
Customizing the perks package.
Registering the company.
Enter the payment information
Inviting employees to participate in the package.

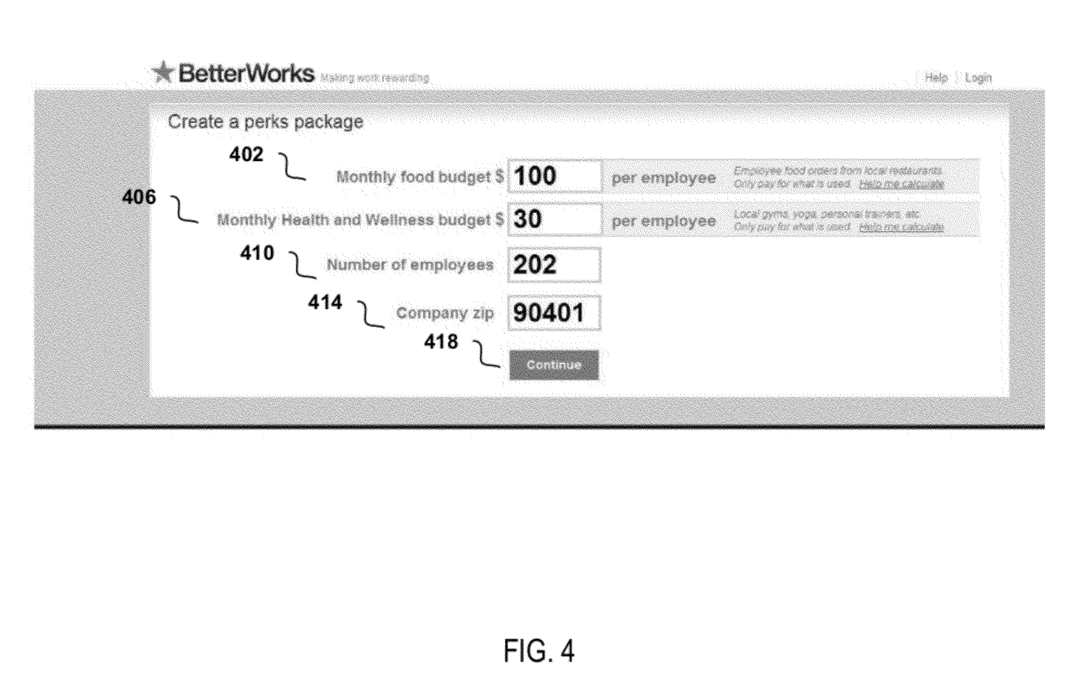

In an embodiment, the first task an employer performs is to determine how much the employer wishes to invest in a perks package. FIG. 4 illustrates an exemplary user interface that enables an employer to estimate the cost of a perks package that includes a monthly food budget 402 (e.g. employees can order food from local restaurants) and a monthly health and wellness budget (e.g. local gym membership) for 410 employees 410 in a particular zip code (90401). In one embodiment, when the employer selects the “Continue” control 418, the estimated total is stored and the process continues to a webpage for customizing the perks package.

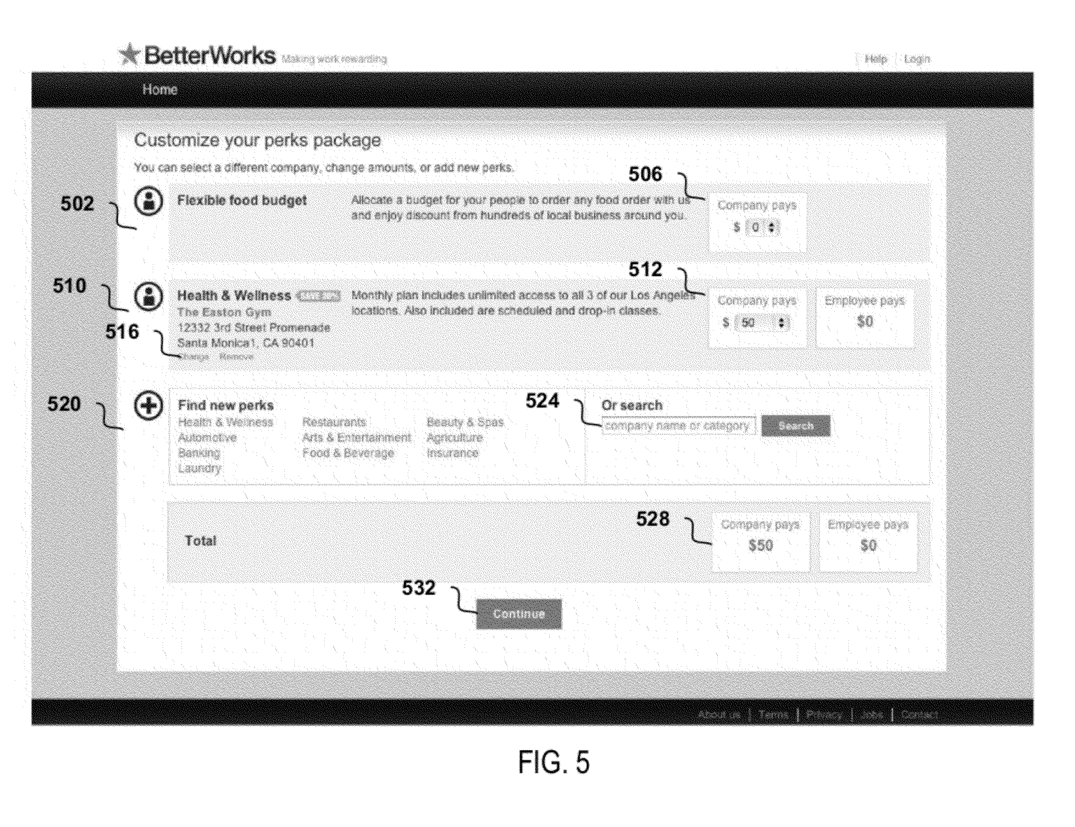

FIG. 5 illustrates an exemplary user interface that enables an employer to customize a perks package. In an embodiment, default company and employee perk selections 502 and 506 co-payment amounts 506 and 512 are displayed, however, the employer can change them. New perks can be added from this page as well. In an embodiment, each perk 502 and 510 comprises
Category name and icon.
Vendor name.
Vendor address.
Vendor phone.
Perk details.
Company co-pay.
Employee co-pay.

In an embodiment, each perk can additionally comprise controls 516 that allow the perk to be changed (e.g. selection of a different gym). In an embodiment, the interface can additionally provide additional elements that allow the employer to search for other perks using, for example, category selections 520 and/or free form search queries 524. In an embodiment, the category and free-form searches only return vendors registered with the employee rewards service. In an embodiment, vendors presented to employers in category 520 and/or freeform search 524 results can be further filtered based on employer location, negotiated rate or preferred placement. As new perks and co-payments are provided, the interface interactively displays total employee and employer co-payments 528 (per employee). When the employer has finished customizing the perks package, the employer selects the continue control, 532 the customized package is stored and the process continues to a webpage for providing basic company information.

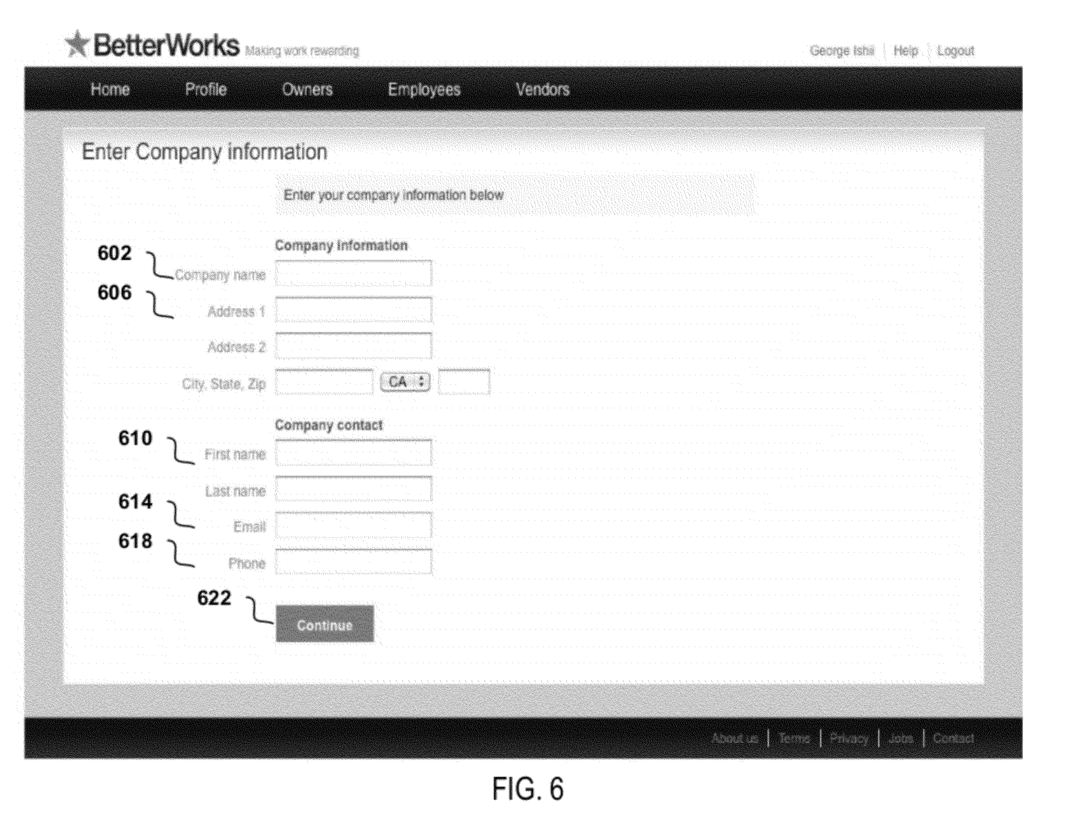

FIG. 6 illustrates an exemplary user interface that enables an employer to provide basic business information to the employee rewards service. In an embodiment, the employer provides a company name 620 and address 606 and a business contact 610, 614 and 618. When the employer has finished entering the employer's basic business information, the employer selects the continue control 622, the business information is stored and the process continues to a webpage for providing payment of employer co-payment amounts.

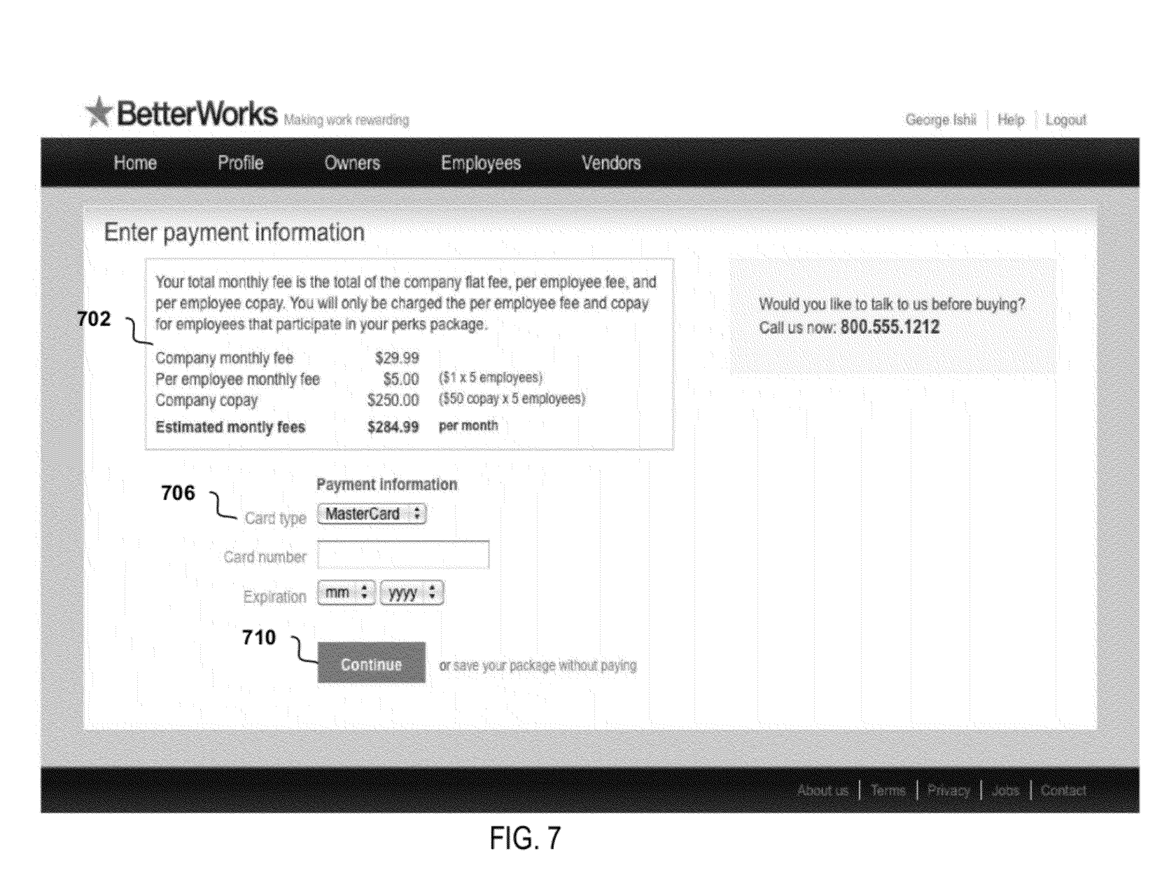

FIG. 7 illustrates an exemplary user interface that enables an employer to provide a means to fund co-payments for employees that participate in the perks package. In an embodiment, the interface displays monthly estimated fees 702, including:
A monthly fee for the employer.
A per employee monthly fee.
The employer's estimated co-payment.

In the illustrated embodiment, the interface permits the employer to pay all fees utilizing a credit or debit card number 706, although in other embodiments payments could be made using any suitable method, for example, direct payment from a checking account. When the employer has finished customizing the perks package, the employer selects the continue control, 710 the payment information is stored, and stored and the process continues to a webpage for inviting employees to participate in the perks package.

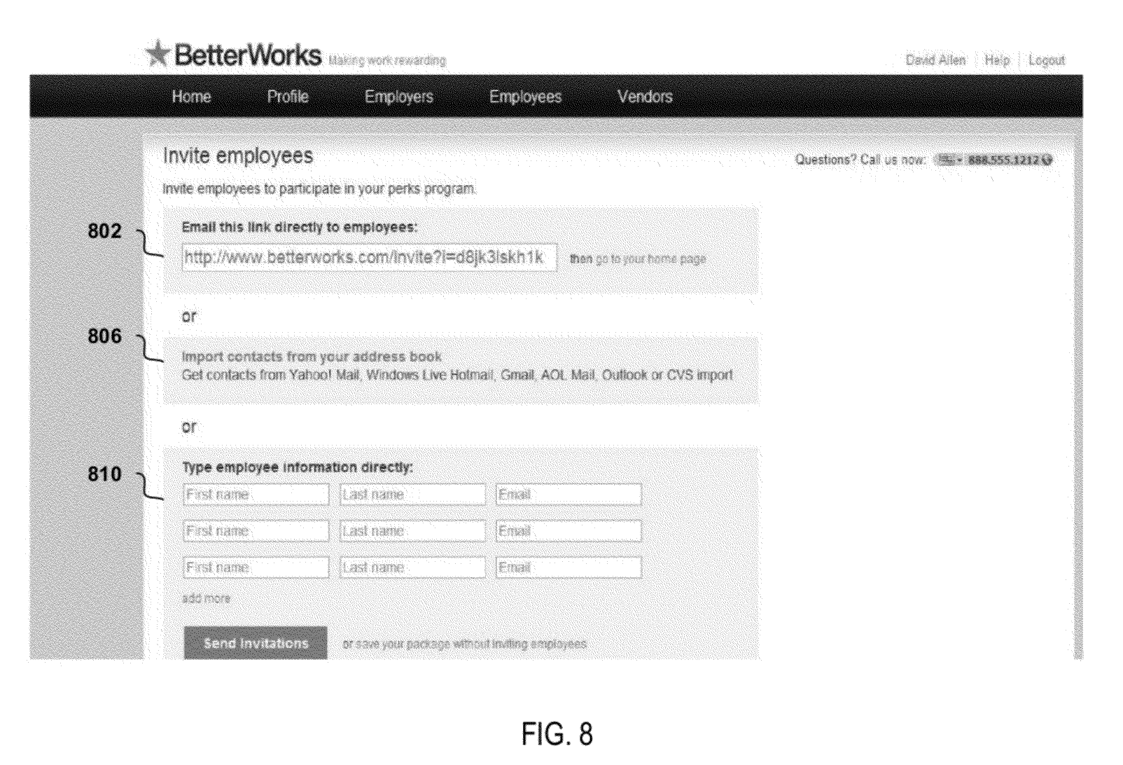

FIG. 8 illustrates an exemplary user interface for inviting employees to participate in a perks package. In an embodiment, the employee rewards service creates a URL 802 that includes a unique invitation code for every perks package. In an embodiment, the employer can simply cut and paste the URL into an email that the employer sends to its employees via any conventional means such as, for example, conventional email or text messaging. In an embodiment, the interface can additionally provide an automated function 806 to send email invitations to all users in a contact list. In an embodiment, the interface can additionally provide text entry boxes 810 that permit the employer to manually names and email addresses.

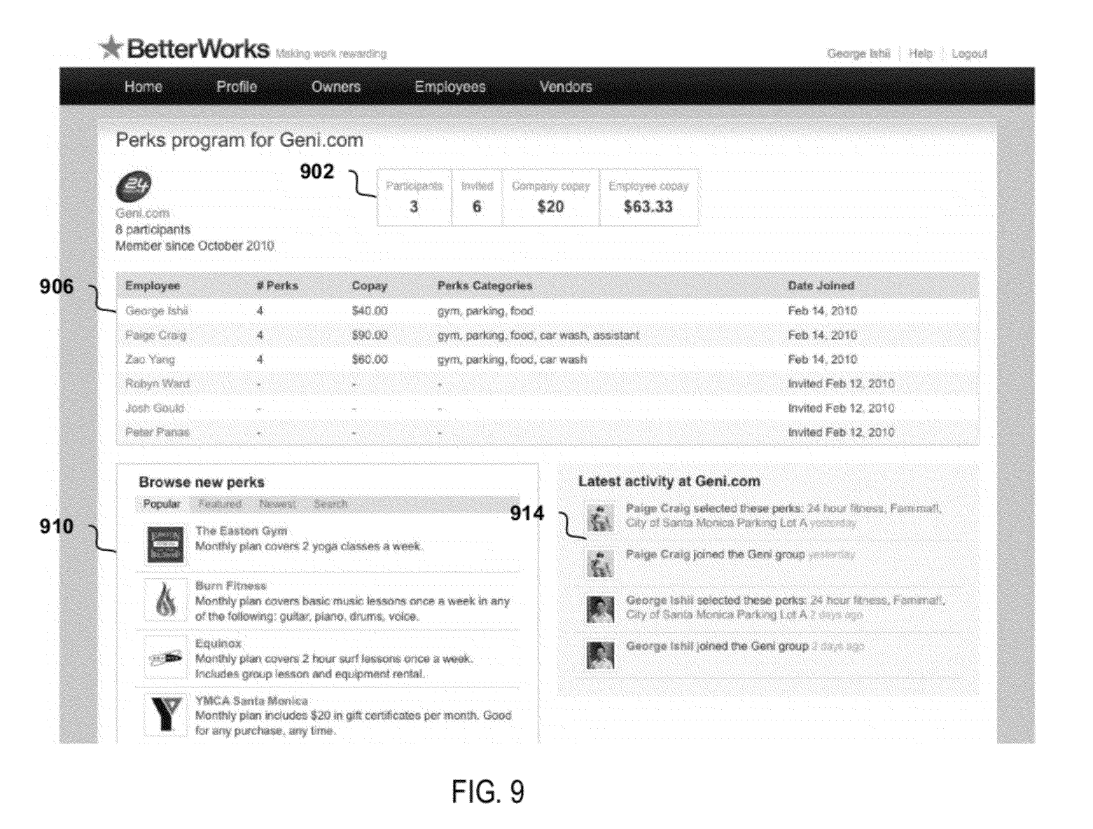

FIG. 9 illustrates an exemplary dashboard that summarizes employee participation in an employer's perks package. In an embodiment, the dashboard provides elements that summarize total the total number of employees invited and participating 902 in the program and individual employees invited and participating 906. In an embodiment, the dashboard can provide elements that permit the employer to browse new perks 910 that could be added to the perks package. In an embodiment, the dashboard can provide elements that permit the employer to view recent employee activity 914, such as perk selection. In an embodiment, the dashboard can additionally provide administrative functions, such as adding, deleting or limiting employees.

### Employee Registration, Exemplary User Interfaces

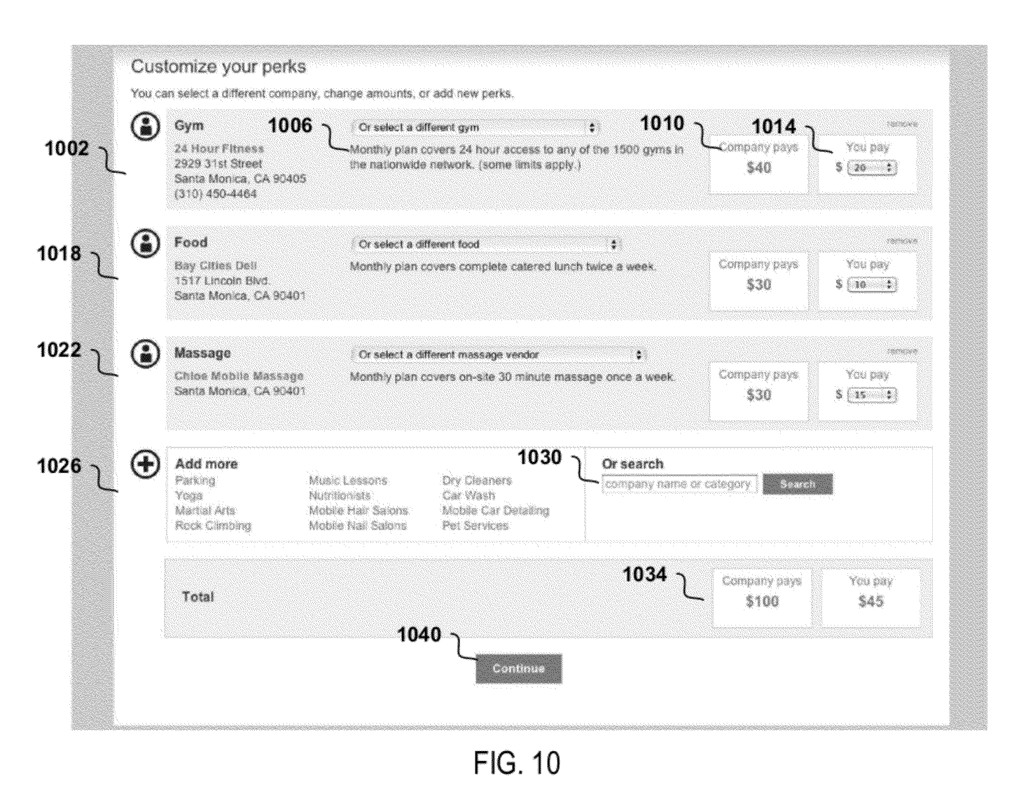

In an embodiment, when an employee receives an email invitation to participate in a perks program, the employ can enroll in the perks program by clicking on the invitation link. The employee can then view and customize the perks package to his or her liking. FIG. 10 illustrates an exemplary user interface that enables an employee to customize his or her participation in a perks program. In the illustrated embodiment, the interface initially displays three default perks 1002, 1014 and 1022 selected by the employer, along with default co-payment amounts, for example, 1010 and 1014. The interface further provides controls, for example, 1006, that allow the employee to make alternative selections for different gyms, restaurants or massage services. The interface further provides controls, for example, 1014, that permits the employee to adjust co-payment amounts up or down.

In an embodiment, the interface can additionally provide additional elements that allow the employee to search for other perks using, for example, category selections 1026 and/or free form search queries 1030. In an embodiment, the interface displays the employer's and the employee's respective co-payment amounts. When the employee has finished customizing the perks package, the employee selects the continue control 1040, the customized package is stored and the process continues to a webpage for the employee to provide contact and payment information.

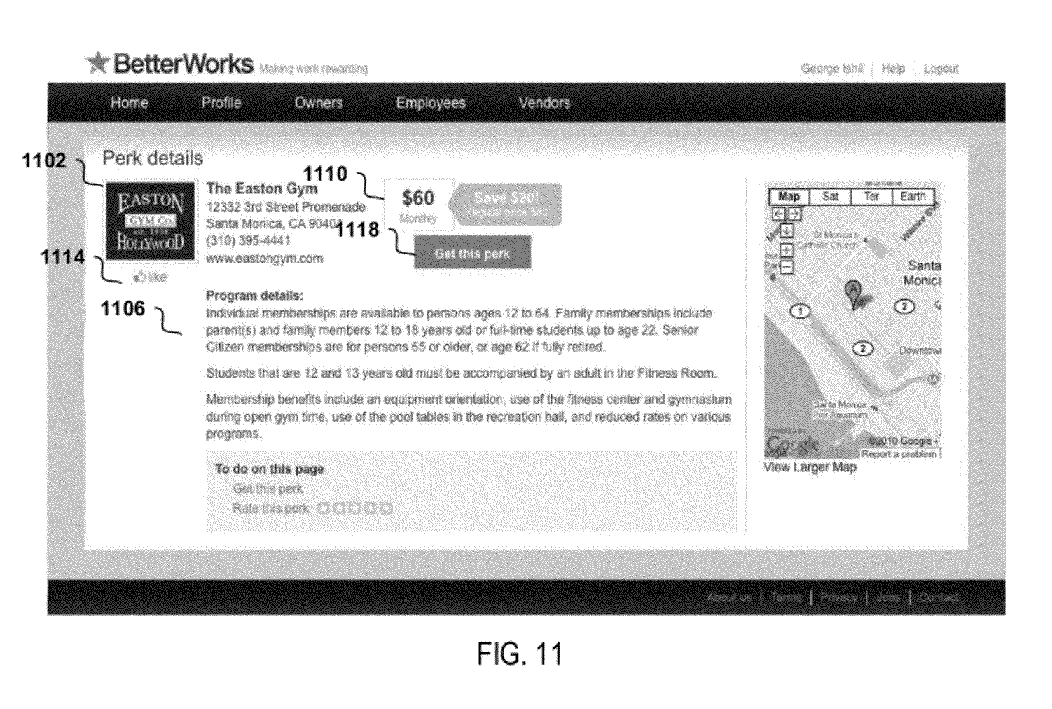

In an embodiment, when an employee searches for perks using, for example, the category 1026 or free form search queries 1030 of FIG. 10, the interface can display perk details utilizing the user interface shown in FIG. 11. In illustrated embodiment, for a given perk, the interface displays the name 1102 of the vendor providing the perk, details 1106 about the perk, the required co-payment for the perk 1110 and controls that permit the employee to rate the perk 1114 and to get the perk 1118.

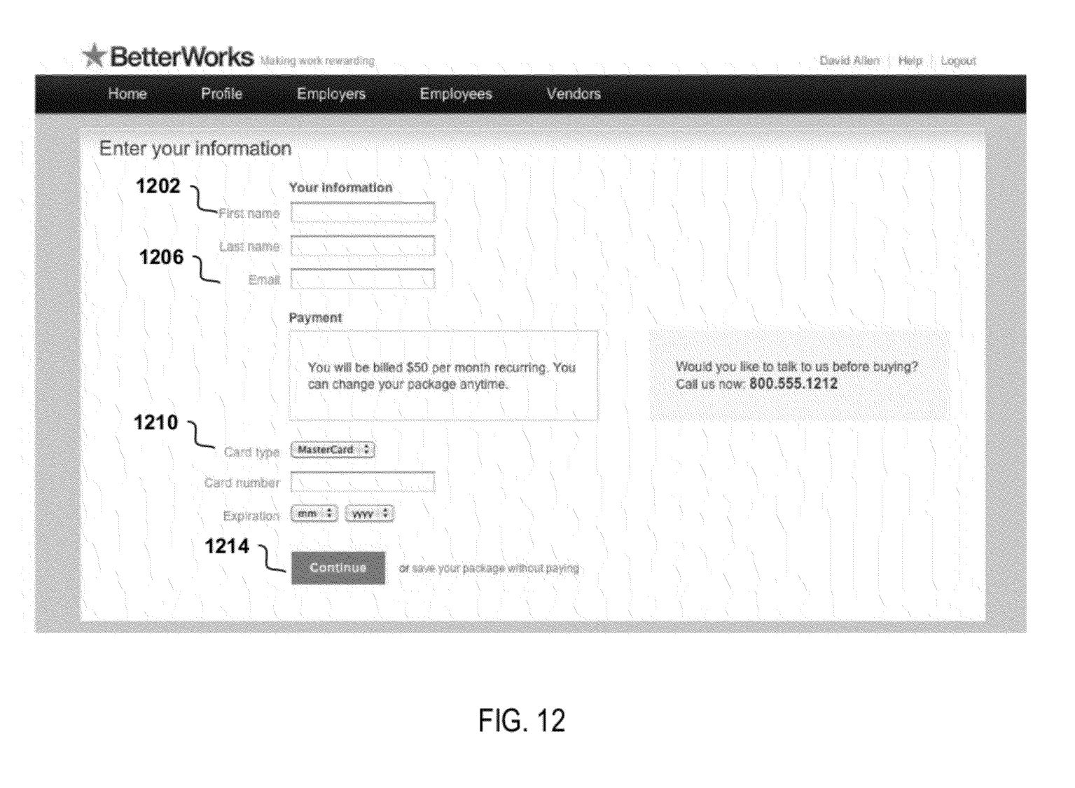

FIG. 12 illustrates an exemplary user interface that enables an employee to provide basic contact information and payment information. In the illustrated embodiment, the interface provides free for text entry boxes for the employee to enter his or her name 1202 and to provide a contact email address. In the illustrated embodiment, the interface permits the employee to pay all fees utilizing a credit or debit card number 1214, although in other embodiments, payments could be made using any suitable method, for example, direct payment from a checking account. When the employee has finished entering in contact and payment information, the employee selects the continue control, 1214 the payment information is stored, and stored and the process continues to a webpage confirming the employee's purchase of one or more perks.

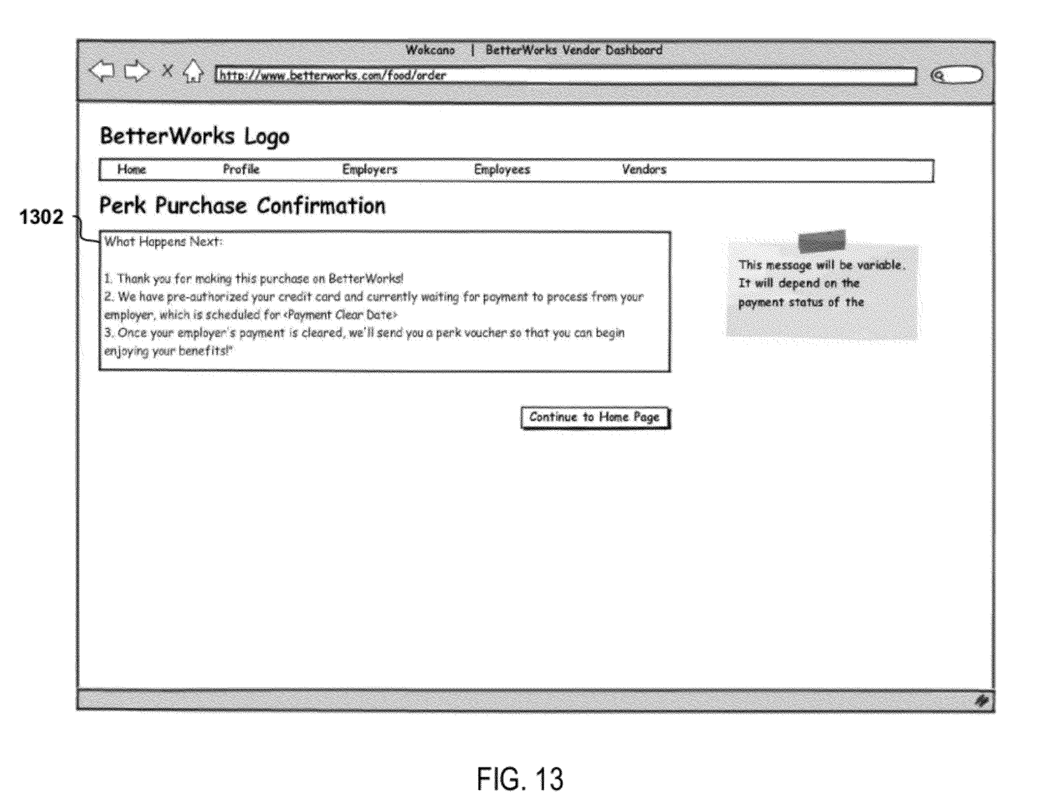

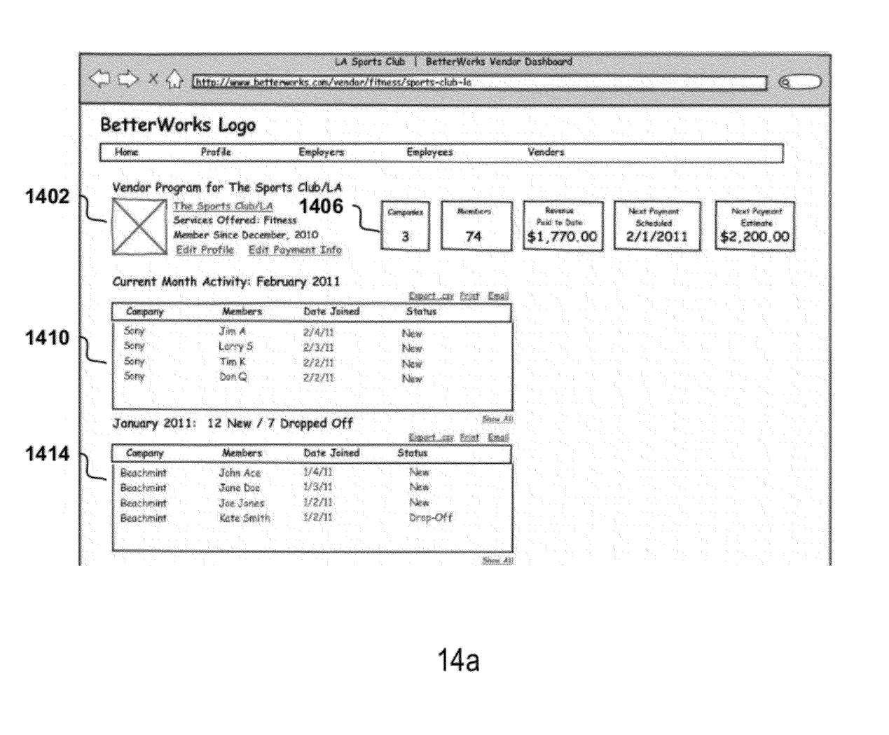

FIG. 13 illustrates an exemplary user interface that confirms an employee's purchase of one or more perks. In various embodiments, the interface provides the employee with instructions 1302 for redeeming the perk. Whether or not the employee can begin using the perk will depend on whether the employer has paid for their share of the perk (if any). This will also determine the message stated. Exemplary messages include:
Message: “Thank you for making this purchase. We will send you your perk voucher within 24 hours, which you can then use to enjoy your benefits! (Condition: Employer payment status is Approved—Employer/employee has a balance in their account which was used to pay for part of the perk.)
Message: “Thank you for making this purchase. We have pre-authorized your credit card and currently waiting for payment to process from your employer. Once your employer's payment is cleared, we'll send you a perk voucher so that you can begin enjoying your benefits!” (Condition: Employer payment status is Pending—The employer/employee has a $0 balance in their pre-allocation account and the employer has agreed to pay for part of the perk.)
Message: “Thank you for making this purchase. We will send you your perk voucher within 24 hours, which you can then use to enjoy your benefits!” (Condition: Employer payment status is N/A—Employer is not paying for any part of the perk.)
Message: Great News! We'd like to offer you a FREE membership to <Membership Vendor Name> for the remainder of this month! (Condition: Vendor has marked the Field that says they will offer free memberships for mid-month signups. And, employee is eligible for Perk (i.e., paid))
Message: Since you had signed up during the middle of the month, we'll only charge you a pro-rated amount for this month's membership to <Membership Vendor Name> based on when your payment goes through) (Condition: Vendor has marked the field that says they will not offer free memberships for mid-months signups.)

### Vendor Registration, Exemplary User Interface

In an embodiment, vendors must register (e.g. be “in network”) with the employee rewards service in order to participate in the employee rewards service. In an embodiment, during registration, the vendor electronically agrees to one or more contracts with the service electronically. In an embodiment, the vendor must support the following functions to participate in the employee rewards service:
Month to month membership.
No initiation fees.
No minimum employment count.
Vendor can receive orders via an automated ordering system.

In an embodiment, the employee rewards service can additionally provide various functions that may be of particular interest to specific vendors:
The vendor can receive payment for services rendered via a single ACH for all participating employees on agreed net payment
The vendor can receive daily emails or check the employee rewards service vendor dashboard (see below) for new members.
The vendor can provide service to members within 24 hours of purchase on the employee rewards service.
The vendor can set up policies for automatically accepting or rejecting orders.

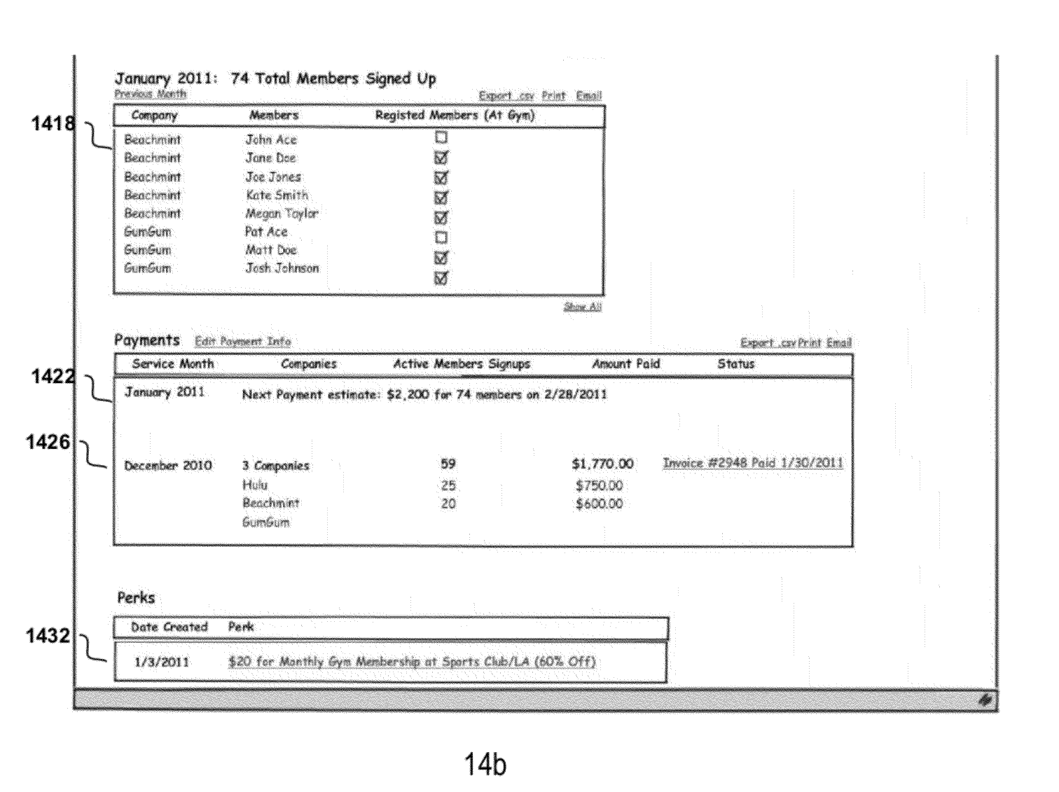

FIGS. 14a and 14b illustrates an exemplary vendor dashboard user interface that enables vendors participating in the employee rewards service to monitor events of interest to the vendors and to maintain a profile for the vendor.

In an embodiment, the vendor dashboard displays the vendor's basic profile information 1402 and provides means for the vendor to specify how the vendor is to be paid. In an embodiment, the dashboard provides summary information 1406 showing the number of companies that are using the vendor in a perks program, the total number of employees (i.e. members) that are using the vendor's services and revenue information showing the revenue paid to the vendor to date, the next scheduled payment to the vendor and an estimate of the next payment to the vendor.

In an embodiment, the vendor dashboard can additionally show membership activity for the current month 1410 and a previous month 1414 relating to the vendor including, for example:
The employer (i.e. company) of individual members (i.e. employees).
The names of individual members.
When the employee joined (i.e. selected the vendor in a perks package).
The status of the employee, such as ‘new’ (just selected the vendor) and ‘drop-off’ (deleted the vendor from the employee's perks package).

In an embodiment, the vendor dashboard can additionally show all members who have selected a perk offered by the vendor including, for example:
The employer (i.e. company) of individual members (i.e. employees).
The names of individual members.
Whether the members have registered for the perk at a location of delivery of the perk (i.e. registered at a gym)

In an embodiment, the vendor dashboard can additionally show more detailed payment (i.e. revenue) information for the current 1422 and a previous month 1426 including, for example:
A next estimated payment for the current month.
Total payments for the previous month.
The invoices for the previous month.
Payments for the previous month by employer.

In an embodiment, the vendor dashboard can additionally show all the perks 1432 (i.e. offers) offered by the vendor and provide means for editing the perks, and adding and deleting perks.

### Exemplary Processes Supported by the Employee Rewards System

It should be understood that the above exemplary user interfaces are purely illustrative, and not intended to be limiting. The following exemplary processes provide additional details relating to the functions that the employee rewards system can provide. It should be understood that, unless clearly stated otherwise, one or more servers such as the employer rewards servers shown in 142 of FIG. 1 perform the operations of the various processes, and employee rewards services databases such as that shown in 144 of FIG. 1 store the data collected and/or stored by the processes.

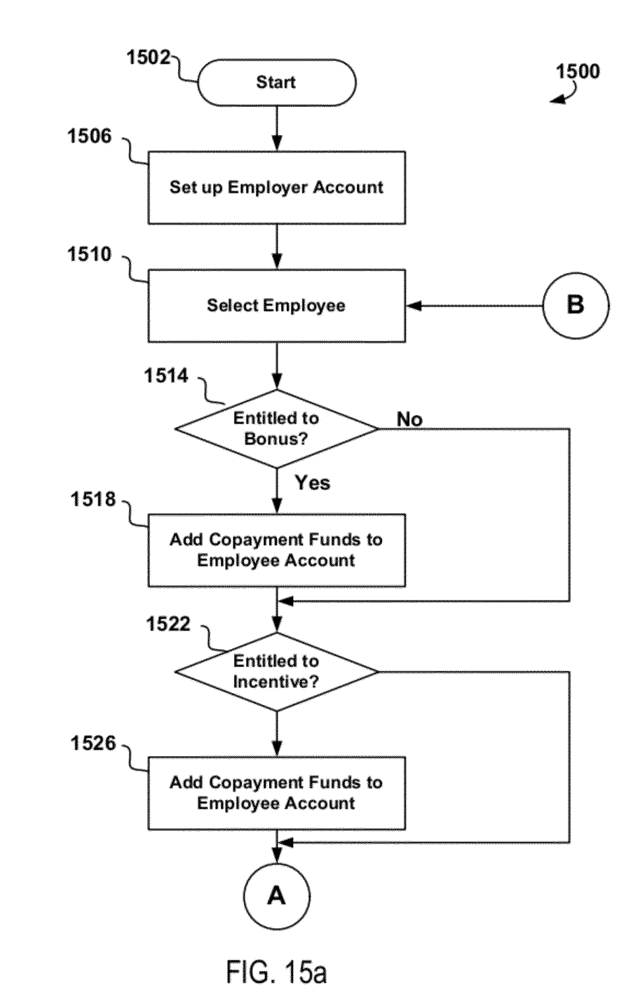

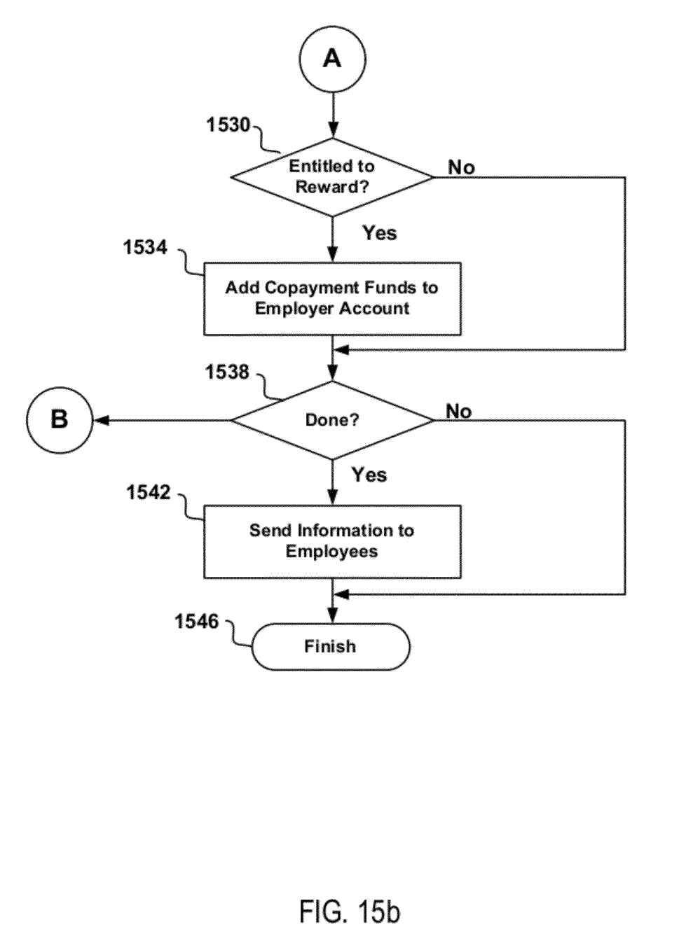

FIG. 15a-15b shows an exemplary procedure 1500 for providing co-payments for employee perks. After starting 1502, the procedure performs a setup 1506 of an employer account such as, for example, shown in FIG. 4-8 above. Then the procedure selects 1510 an employee to receive co-payments for perks in a perks package. Although listed in an order in FIG. 15a and FIG. 15b, the next set of steps (1514, 1518, 1522, 1526, 1530, and 1534) do not have to be performed in the order shown. The procedure determines if the selected employee is entitled to a bonus 1514. If so, co-payment funds are added 1518 to an account for the employee. If not, no funds are added. Note that these are pre-paid funds that allow employers to pre-pay co-payments into the employee's account. The procedure can additionally determine if the selected employee is entitled to an incentive 1522. Again, if so, co-payment funds are added 1526 to the employee's account, but if not, no funds are added. The procedure can additionally determine if the selected employee is entitled to a reward 1530, co-payment funds are added 1534 to the selected employee's account, otherwise not.

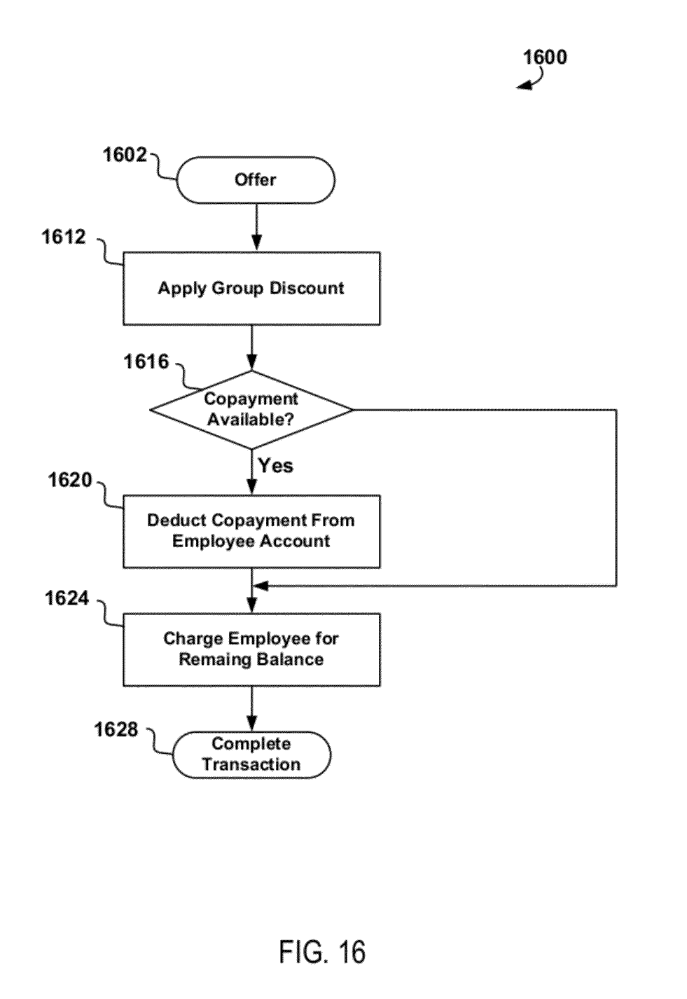

When the process has finished updating the selected employee's account, a new employee is selected and the procedure repeats until all employee accounts have been updated 1538. An employee is able to logon to the account and then select goods or services that are, for example, locally available, such as shown in FIGS. 10 and 11 above. As employees use the system, goods and services co-payment amounts will be decremented from the employer's account. Employees can additionally provide information relating to employee financial accounts such as, for example, employee credit cards, debit cards and checking accounts which can be used to fund the purchase of perks where employer co-payments do not cover the cost of perks in whole or in part, as shown, for example, in FIGS. 12 and 16. The system will then determine how properly to fulfill orders for the goods or services. This determination may depend on the how the orders are placed, whether online, in person, by fax, mail, email, or other means and the procedure notifies the employees how to obtain the goods and services they have selected as shown, for example, in FIG. 13. After information is gathered and sent, the procedure finishes 1546.

FIG. 16 shows an exemplary procedure 1600 an employee may use to purchase goods or services using a co-payment account. An employee's acceptance of a an offer 1602. is received. A group discount is applied 1612 to the cost of the offer, Then it is determined if there is an amount sufficient 1616 for a co-payment in the employer's account. If so, then the required co-payment is deducted 1620 from the account and applied to the purchase price. Any remaining amount due may then be charged 1624 to the employee. Upon applying the payment(s), the transaction is completed 1628. This procedure 1600 may be used for both one-time and recurring payments. And at various points during the procedure 1600, the employee may choose to abort the transaction and rollback any deductions.

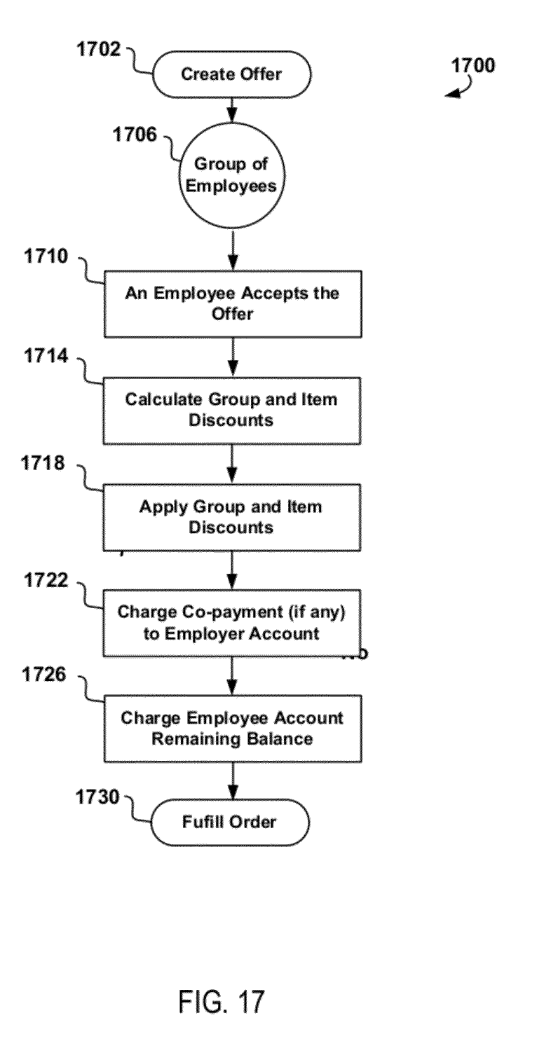

FIG. 17 shows how an offer can be made to a group of employees simultaneously. An example of where this is useful is in the context of an employee luncheon. A vendor or an employer creates an offer for a perk 1702 (with may or may not include a copayment) which is available to a group of employees 1706. An employee of the group of employees accepts 1710 the offer via online facilities provided by the employee rewards service such as shown, for example, in FIG. 10-13 (discussed above). In the example of a luncheon, employees might review a menu before accepting—individual acceptances might differ in number and kind of menu items selected. Group and item by item discounts are calculated 1714 and applied 1718 to the cost of the perk. A co-payment amount for the perk (if any) is charged to an employer account. Any remaining amount due is charged 1726 to the employee's account and the order is then fulfilled 1738.

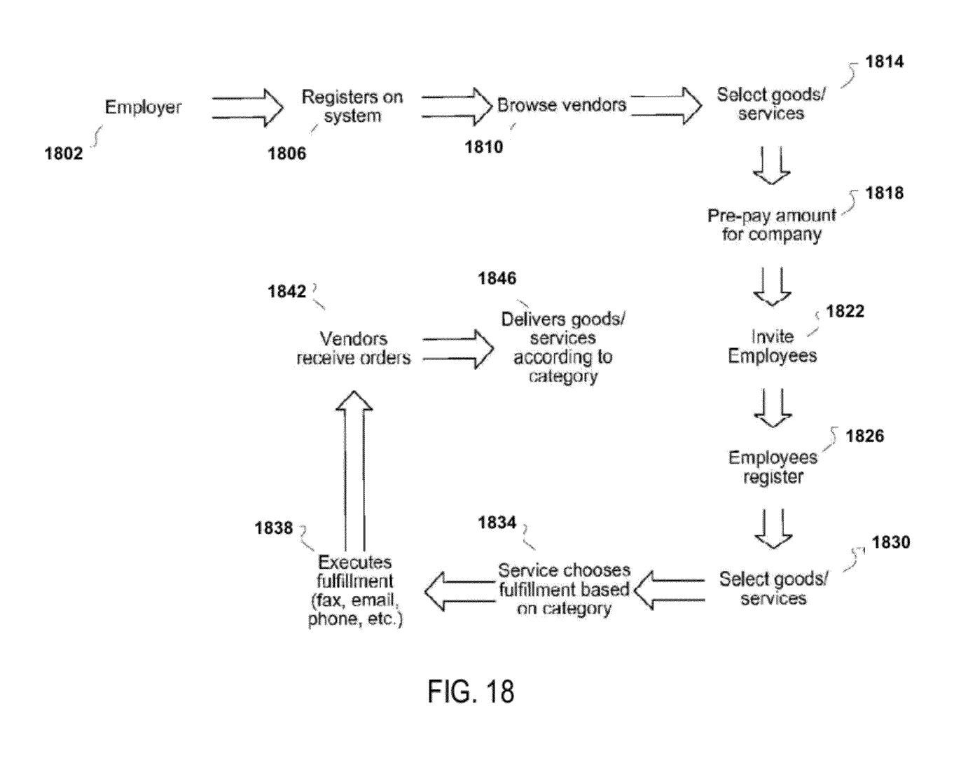

FIG. 18 illustrates an exemplary interaction among an employer, vendors, employees, and the employee rewards service. The employer 1802 registers 1806 on a system of the employee rewards service such as, for example FIG. 4-8. Then the employer may browse 1810 through available vendors, who may be local to the employees. The employer selects 1814 goods and services that it wishes to provide to its employees on a discounted and/or co-payment basis, for example, as shown in FIG. 5. The employee rewards service then accepts 1818 pre-payment from the employer's company and sets up payment plans and co-payment accounts for individual employees, for example, as shown in FIGS. 7 and 12.

In an alternative embodiment, the employer may decide to pay as it goes. The employer then invites 1822 employees to participate and interested employees register 1826 with the employee rewards service. Then, employees select 1830 goods and services of interest. The employee rewards service chooses 1834 the manner of fulfillment of orders of the selected goods and services based upon the category of individual employees. Then the employee rewards service requests that the vendors (whether contacted in person, online, by mail, by email, by voice telephone, by texting etc.) execute 1838 fulfillment of the orders. The vendors 1842 receive the orders and deliver 1846 goods and services. The employee rewards service reconciles payment to the vendors with discounts and co-payments according to categories of the individual employees and properly charges the individual employees any residual amounts (e.g. by charge card or electronic funds transfer).

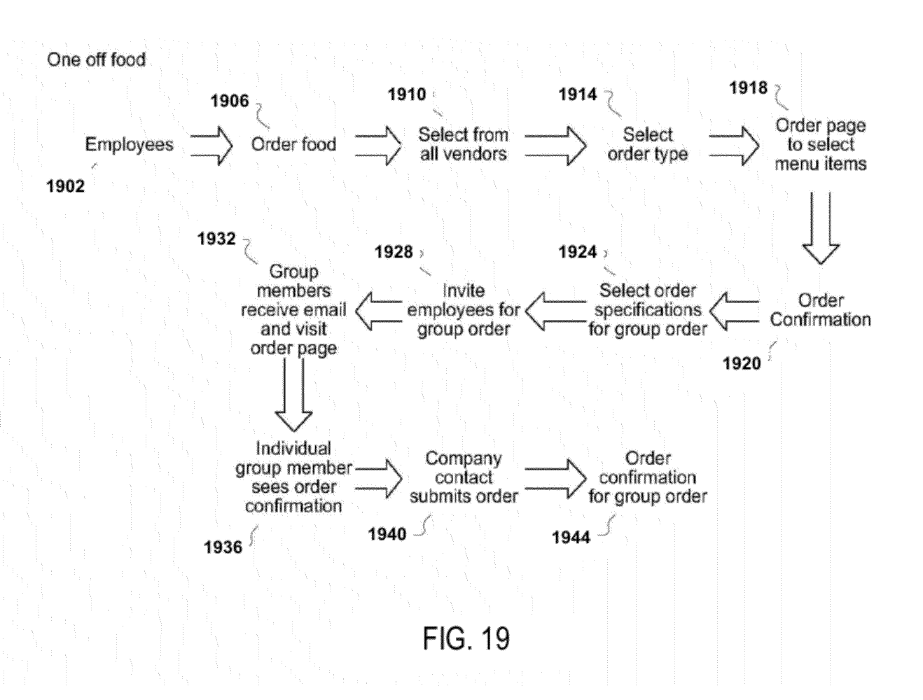

FIG. 19 illustrates an exemplary interaction among an employer, vendors, employees, and the employee rewards service in relation to food services. While this embodiment is specific to particular goods and services, it is readily apparent that it also encompasses other forms of goods and services. Assume employees 1902 want to place a collective order for food 1906. There is a group of food vendors on a list compiled by the employer and supplied to the employee rewards service.

One or more employee makes a selection 1910 of one or more vendors from a list vendors appropriate to the occasion (e.g. an in-house luncheon or dinner). An order type is selected 1914 (e.g. hot or cold food). Alternate individual food items may be selected from menu(s) (e.g. vegetarian or kosher) and may be placed 1918 on an order page. The employees confirm 1920 the order page with the vendor(s) and specifications are drawn 1924 setting parameters for individual employee choices. At this point, the employees on the order can invite 1928 other employees to participate in a group order. The contact can send out an invitation by various means as discussed above.

Upon receiving the invitation, the employees, who are group members, may visit 1932 the order page. They make food item selections from the order page and individual group members receive 1936 order confirmation. The order is then submitted 1940 in conformance with the individual group members' selections, to the vendor(s) (again by various means). Then, the vendor(s) may return 1944 order confirmations and execute the orders. During this process, the employee rewards service reconciles discounts, co-payments, and residual payments according to vendor(s) and individual employee accounts.

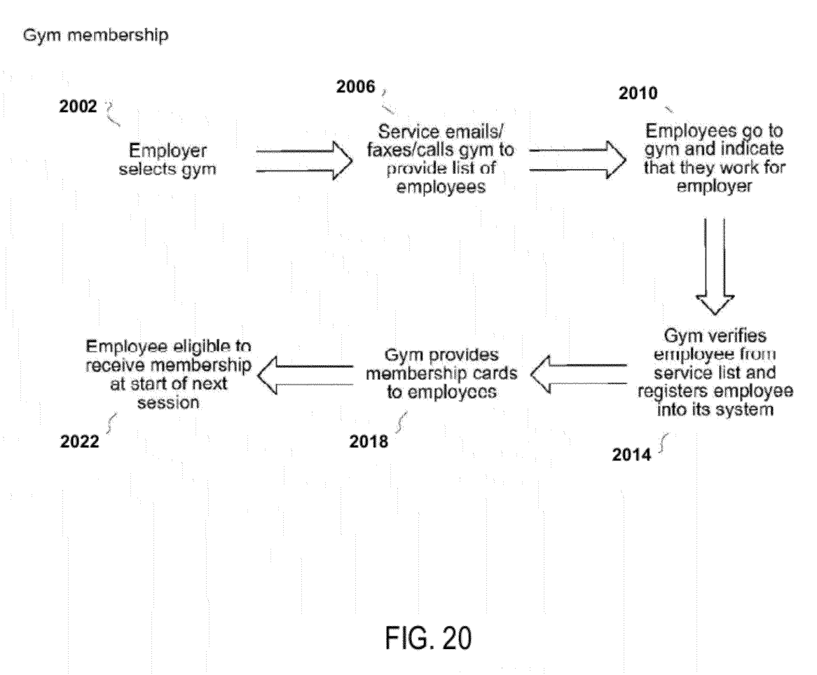

FIG. 20 illustrates an exemplary interaction among an employer, vendors, employees, and the employee rewards service in relationship to a gym or health club membership. While this embodiment is specific to a particular employee rewards service, it is readily apparent that it also encompasses other forms of services (e.g. memberships in professional or fraternal organizations). At step 2002, the employer selects one or more gyms preferably local to the individual employees. After notifying the employee rewards service of the choice(s), the employee rewards service contacts the gyms(s) (by various means listed above) and provides 2006 a list of eligible employees to the gym(s). The individual employees then contact a gym (in person or otherwise) and indicate 2010 that the employee works for the employer. The gym verifies from the list, that the employee rewards service provided, that the employee is eligible and registers 2014 the employee into the gym's system. Then the gym optionally provides 2018 a membership card to the employee and makes the employee eligible 2022 to enroll immediately or in the next session (e.g. at the start of a class).

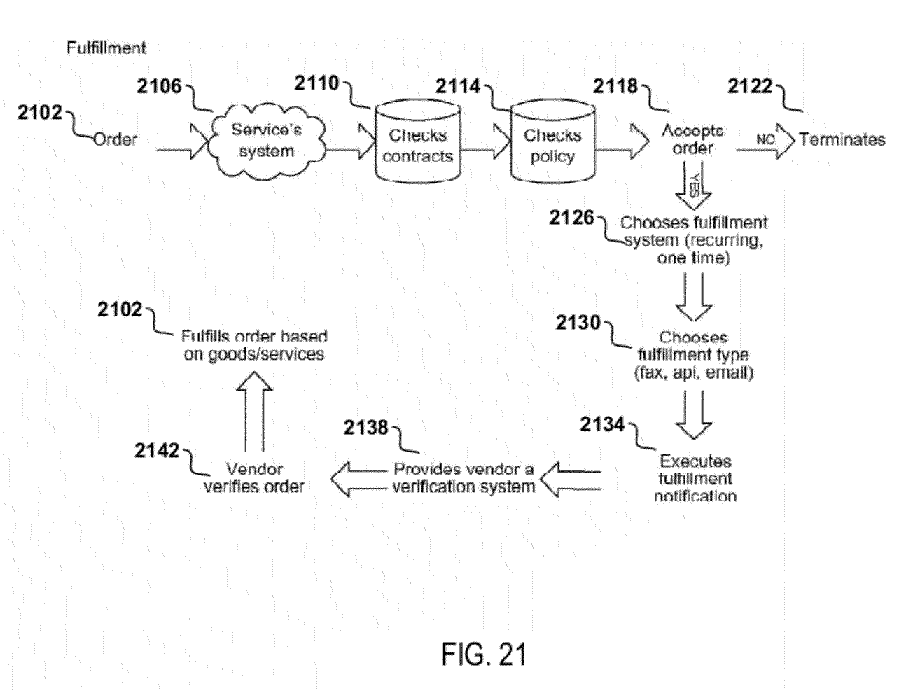

FIG. 21 illustrates an exemplary interaction among an employer, vendors, employees, and the employee rewards service in relationship to fulfilling an order. In response to receiving an order 2102 for a perk from an employee via the services systems, the employee rewards service determines if the vendor 2110 has a contract with the employee rewards service and determines if the order meets the vendor's policies 2114. If the vendor has a contract with the service and the order meets the vendor's policies, the order is accepted 2118, if not, the order is rejected. If the order is accepted, the employee rewards system then determines if fulfillment should be one-time or recurring 2126 and determines how fulfillment should be handled (e.g. via fax, email or online via, for example, an API. The employee rewards service then notifies the vendor of the order 2134 and provides the vendor means to verify the order 2138. When the vendor verifies the order, the employee rewards service coordinates fulfillment of the order 2146.

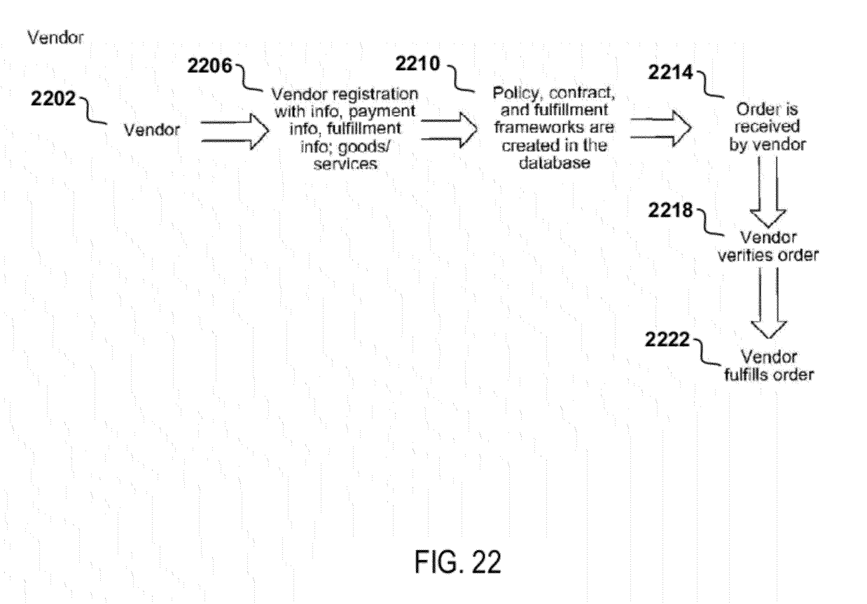

FIG. 22 illustrates an exemplary interaction between a vendor and the employee rewards service. A vendor 2202 registers 2206 with the employee rewards system and provides, inter alia, information relating to the vendor including, without limitation, payment information, fulfillment information and goods and services offered by the vendor. See, for example, FIG. 14a-b, showing the various types of information relating to vendors stored by the system. Policy, contract and fulfillment frameworks are created 2210 in the employee rewards system databases. When the vendor 2202 receives an order for a perk or other offering 2214, the vendor 2202 verifies 2218 the order and fulfills it 2222.

While some embodiments can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system, middleware, service delivery platform, SDK (Software Development Kit) component, web services, or other specific application, component, program, object, module or sequence of instructions referred to as “computer programs.” Invocation interfaces to these routines can be exposed to a software development community as an API (Application Programming Interface). The computer programs typically comprise one or more instructions set at various times in various memory and storage devices in a computer, and that, when read and executed by one or more processors in a computer, cause the computer to perform operations necessary to execute elements involving the various aspects.

A machine readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others.

In general, a machine readable medium includes any mechanism that provides (e.g., stores) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

Although some of the drawings illustrate a number of operations in a particular order, operations which are not order dependent may be reordered and other operations may be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A method comprising:
transmitting, over the network, to an employer, vendor information relating to each vendor of a plurality of vendors, the vendor information of each respective vendor of the plurality of vendors comprising a respective offering of the vendor, the respective offering comprising a respective description of the respective offering and a respective cost of the respective offering
receiving, over the network, a selection of a respective offering of a respective vendor of the plurality of vendors, the selection comprising a co-payment amount;
creating, via a computing device, a benefits package comprising information relating to the respective offering of the respective vendor of the plurality of vendors and the co-payment amount;
transmitting, over the network, to an employee of the employer, an invitation to participate in the benefits package;
receiving, over the network, from the employee, an acceptance of the invitation to participate in the benefits package;
charging the employer the co-payment amount;
charging the employee an amount equal to the cost of the respective offering of the respective vendor of the plurality of vendors net of the co-payment amount; and
creating an order for the respective offering of the respective vendor of the plurality of vendors on behalf of the employee.

2. The method of claim 1 further comprising:
providing for fulfillment of the order.

3. The method of claim 2 further comprising:
compensating the respective vendor of the plurality of vendors for the a respective cost of the respective offering.

4. The method of claim 1 wherein the respective offering of the respective vendor of the plurality of vendors relates to a location that is in a local proximity to a location of the employer.

5. The method of claim 1 further comprising:
determining the respective offering of the respective vendor of the plurality of vendors is subject to a group discount;
in response to determining the respective offering of the respective vendor of the plurality of vendors is subject to a group discount, calculating a reduced offering cost using the group discount,
wherein the co-payment amount is less than the reduced offering cost, the employer is charged the co-payment amount and the employee is charged an amount equal to the reduced offering cost net of the co-payment amount, and
wherein the co-payment amount is not less than the reduced offering cost, the employer is charged the reduced offering cost and the employee is not charged.

6. The method of claim 1 further comprising:
determining the respective offering of the respective vendor of the plurality of vendors is subject to an item discount;
in response to determining the respective offering of the respective vendor of the plurality of vendors is subject to an item discount, calculating a reduced offering cost using the item discount,
wherein the co-payment amount is less than the reduced offering cost, the employer is charged the co-payment amount and the employee is charged an amount equal to the reduced offering cost net of the co-payment amount, and
wherein the co-payment amount is not less than the reduced offering cost, the employer is charged the reduced offering cost and the employee is not charged.

7. The method of claim 2 wherein providing for fulfillment of the order comprises:
providing, over the network, instructions to the employee for obtaining the respective offering of the respective vendor of the plurality of vendors.

8. The method of claim 7 wherein the instructions for obtaining the respective offering of the respective vendor of the plurality of vendors comprises a voucher.

9. The method of claim 2 wherein providing for fulfillment of the order comprises:
providing, over the network, instructions to the respective vendor of the plurality of vendors to provide the respective offering to the employee

10. The method of claim 1 further comprising:
pre-allocating an amount to an employer account,
wherein charging the employer the co-payment amount comprises charging the employer account the co-payment amount,
wherein, the employee is not charged until the co-payment amount is charged to the employer account.

11. The method of claim 10 wherein the co-payment amount is not charged to the employer account where the amount in the employer account is less than the co-payment amount, and the co-payment amount is placed in a pending status.

12. The method of claim 11 wherein the employee is notified that the co-payment amount is in a pending status and an employee account is pre-authorized for a charge in the amount equal to the cost of the respective offering of the respective vendor of the plurality of vendors net of the co-payment amount.

13. The method of claim 12 wherein the pre-authorized charge is not applied to the employee account until the co-payment amount is charged to the employer account.

14. The method of claim 1 further comprising:
pre-allocating an amount to an employee account,
wherein charging the employee the co-payment amount comprises charging the employee account the amount equal to the cost of the respective offering of the respective vendor of the plurality of vendors net of the co-payment amount.

15. The method of claim 14 wherein pre-allocating an amount to an employee account, comprises pre-allocating the amount to an employee account using an employee credit card, such that
wherein the amount in the employee account is less than the amount equal to the cost of the respective offering of the respective vendor of the plurality of vendors net of the co-payment amount, the employee credit card is charged an additional amount.

16. The method of claim 14 wherein pre-allocating an amount to an employee account, comprises pre-allocating the amount to an employee account from an employer account.

17. The method of claim 15 wherein the amount is pre-allocated an amount to the employee from the employer account where the employee qualifies for one of a reward, a bonus and an incentive.

18. The method of claim 1 wherein the order is created on a recurring basis.

19. A machine readable media storing instructions that, when executed by a data processing system, cause the data processing system to perform a method, the method comprising:
transmitting, over the network, to an employer, vendor information relating to each vendor of a plurality of vendors, the vendor information of each respective vendor of the plurality of vendors comprising a respective offering of the vendor, the respective offering comprising a respective description of the respective offering and a respective cost of the respective offering;
receiving, over the network, a selection of a respective offering of a respective vendor of the plurality of vendors, the selection comprising a co-payment amount;
creating a benefits package comprising information relating to the respective offering of the respective vendor of the plurality of vendors and the co-payment amount;
transmitting, over the network, to an employee of the employer, an invitation to participate in the benefits package;
receiving, over the network, from the employee, an acceptance of the invitation to participate in the benefits package;
charging the employer the co-payment amount;
charging the employee an amount equal to the cost of the respective offering of the respective vendor of the plurality of vendors net of the co-payment amount; and
creating an order for the respective offering of the respective vendor of the plurality of vendors on behalf of the employee.

20. A computer system comprising:
a memory; and
at least one processor coupled to the memory to:
transmit, over the network, to an employer, vendor information relating to each vendor of a plurality of vendors, the vendor information of each respective vendor of the plurality of vendors comprising a respective offering of the vendor, the respective offering comprising a respective description of the respective offering and a respective cost of the respective offering
receive, over the network, a selection of a respective offering of a respective vendor of the plurality of vendors, the selection comprising a co-payment amount;
create, via a computing device, a benefits package comprising information relating to the respective offering of the respective vendor of the plurality of vendors and the co-payment amount;
transmit, over the network, to an employee of the employer, an invitation to participate in the benefits package;
receive, over the network, from the employee, an acceptance of the invitation to participate in the benefits package;
charge the employer the co-payment amount;
charge the employee an amount equal to the cost of the respective offering of the respective vendor of the plurality of vendors net of the co-payment amount; and
create an order for the respective offering of the respective vendor of the plurality of vendors on behalf of employee.
